(19) United States
(12) Patent Application Publication
(10) Pub. No.: US 2013/0086920 A1
(43) Pub. Date: Apr. 11, 2013

(54) COMBUSTOR AND METHOD FOR SUPPLYING FLOW TO A COMBUSTOR

(71) Applicants: Wei Chen, Greer, SC (US); David Leach, Simpsonville, SC (US); Stephen Kent Fulcher, Greenville, SC (US); John M. Matthews, Greer, SC (US)

(72) Inventors: Wei Chen, Greer, SC (US); David Leach, Simpsonville, SC (US); Stephen Kent Fulcher, Greenville, SC (US); John M. Matthews, Greer, SC (US)

(73) Assignee: GENERAL ELECTRIC COMPANY, Schenectady, NY (US)

(21) Appl. No.: 13/253,500

(22) Filed: Oct. 5, 2011

(51) Int. Cl. F02C 6/08; F02C 7/18

(52) U.S. Cl. 60/782; 60/785; 60/756

(57) ABSTRACT

A device for supplying flow to a combustor includes a flow sleeve configured to circumferentially surround the combustor, wherein the flow sleeve defines a first annular passage around the combustor. A first section of the first annular passage converges at a first convergence rate. A second section of the first annular passage downstream from the first section converges at a second convergence rate that is less than the first convergence rate. A method for supplying flow to a combustor includes flowing a first portion of a working fluid substantially axially through a first annular passage, converging the first annular passage at a first convergence rate, and converging the first annular passage at a second convergence rate downstream from the first convergence rate, wherein the second convergence rate is less than the first convergence rate.

### FIELD OF THE INVENTION

The present invention generally involves a combustor and method for supplying flow to a combustor. In particular embodiments, the combustor and method provide axial flow of a working fluid across the combustor.

### BACKGROUND OF THE INVENTION

Combustors are commonly used in industrial and commercial operations to ignite fuel to produce combustion gases having a high temperature and pressure. For example, industrial gas turbines typically include one or more combustors to generate power or thrust. A typical commercial gas turbine used to generate electrical power includes an axial compressor at the front, one or more combustors circumferentially arranged around the middle, and a turbine at the rear. Ambient air may be supplied to the compressor, and rotating blades and stationary vanes in the compressor progressively impart kinetic energy to the working fluid (air) to produce a compressed working fluid at a highly energized state. The compressed working fluid exits the compressor and flows through one or more nozzles in each combustor where the compressed working fluid mixes with fuel and ignites in a combustion chamber to generate combustion gases having a high temperature and pressure. The combustion gases flow to the turbine to produce work. For example, expansion of the combustion gases in the turbine may rotate a shaft connected to a generator to produce electricity.

It is well-known that the thermodynamic efficiency of the gas turbine generally increases with higher combustion gas temperatures. However, higher combustion gas temperatures may also increase the production of undesirable emissions, reduce the design margins for flash back and/or flame holding, and/or expose various combustor components to excessive temperatures. As a result, a variety of techniques exist to allow higher combustion gas temperatures while minimizing undesirable exhaust emissions, flash back, flame holding, and excessive temperatures. Many of these techniques seek to enhance uniform mixing of the fuel and compressed working fluid prior to combustion to reduce or prevent localized hot spots in the combustion chamber associated with the undesirable emissions, flash back, and/or flame holding.

Additional techniques seek to increase cooling to the combustor components to prevent excessive temperatures from damaging the combustor components. Specifically, a portion of the working fluid may be directed across the outside of the combustor components exposed to the higher temperature combustion gases to provide impingement, convective, and/or conductive cooling to the combustor components. Axial injection of the working fluid across the outside of the combustor components reduces the pressure loss of the working fluid across the combustor, which in turn increases the combustion gas flow and overall efficiency of the gas turbine. Therefore, an improved combustor and method for supplying axial flow across the outside of the combustor components would be useful.

### BRIEF DESCRIPTION OF THE INVENTION

Aspects and advantages of the invention are set forth below in the following description, or may be obvious from the description, or may be learned through practice of the invention.

One embodiment of the present invention is a device for supplying flow to a combustor. The device includes a flow sleeve configured to circumferentially surround the combustor, wherein the flow sleeve defines a first annular passage around the combustor. A first section of the first annular passage converges at a first convergence rate. A second section of the first annular passage downstream from the first section converges at a second convergence rate that is less than the first convergence rate.

Another embodiment of the present invention is a combustor that includes a liner that at least partially defines a combustion chamber. A flow sleeve circumferentially surrounds the liner, and the liner and the flow sleeve define a first annular passage between the liner and the flow sleeve. A first section of the first annular passage converges at a first convergence rate, and a second section of the first annular passage downstream from the first section converges at a second convergence rate that is less than the first convergence rate.

The present invention may also include a method for supplying flow to a combustor. The method includes flowing a first portion of a working fluid substantially axially through a first annular passage that circumferentially surrounds at least a portion of a combustion chamber. The method further includes converging the first annular passage at a first convergence rate and converging the first annular passage at a second convergence rate downstream from the first convergence rate, wherein the second convergence rate is less than the first convergence rate.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section view of an exemplary combustor within the scope of various embodiments of the present invention;

FIG. 2 is a perspective, partial cut-away view of a portion of the combustor shown in FIG. 1 according to one embodiment of the present invention;

FIG. 3 is an enlarged perspective, partial cut-away view of a portion of the combustor shown in FIG. 2 according to one embodiment of the present invention; and

FIG. 4 is a side cross-section view of the first annular passage shown in FIG. 3.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “upstream” and “downstream” refer to the relative location of components in a fluid pathway. For example, component A is upstream of component B if a fluid flows from component A to component B. Conversely, component B is downstream of component A if component B receives a fluid flow from component A. In addition, as used herein, the terms “first”, “second”, and “third” may be used interchangeably to distinguish one component from another and are not intended to signify particular structure, location, function, or importance of the individual components.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a combustor and method for supplying flow to the combustor. The combustor and method may include an axial injection flow sleeve that circumferentially surrounds a combustion liner to form a venturi-shaped annular passage between the flow sleeve and the liner. The annular passage generally includes an axial injection inlet followed by converging and diverging heights or distances between the flow sleeve and the liner. In this manner, the axial injection flow sleeve may enhance cooling to the liner, smoothly merge multiple axial flows across the liner, and/or reduce pressure and/or flow losses across the liner. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor unless specifically recited in the claims.

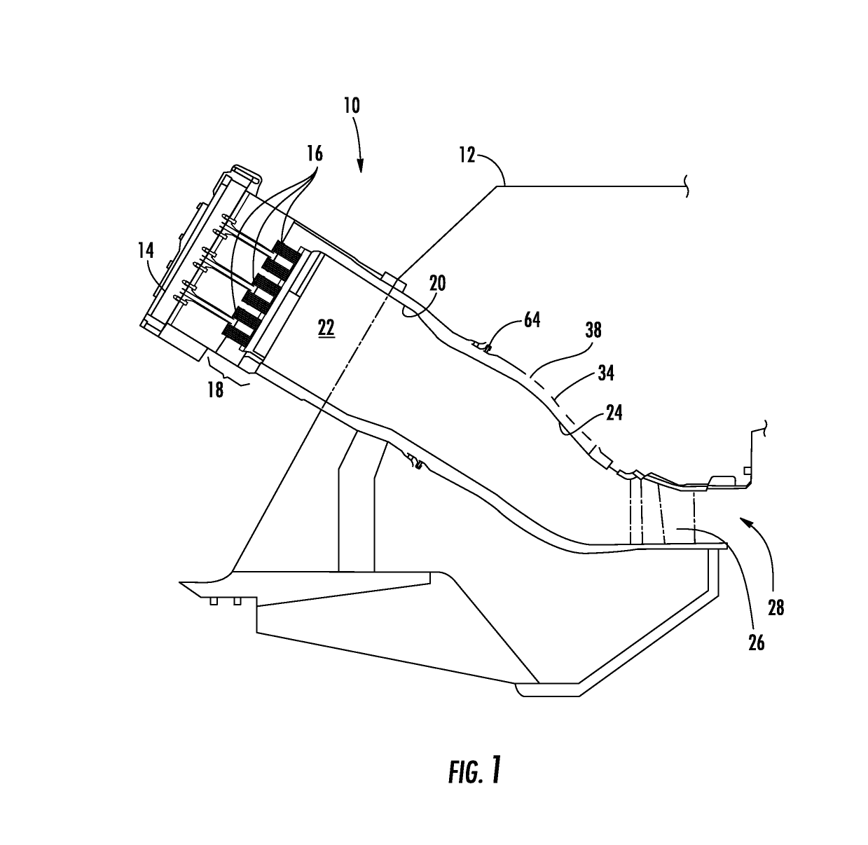

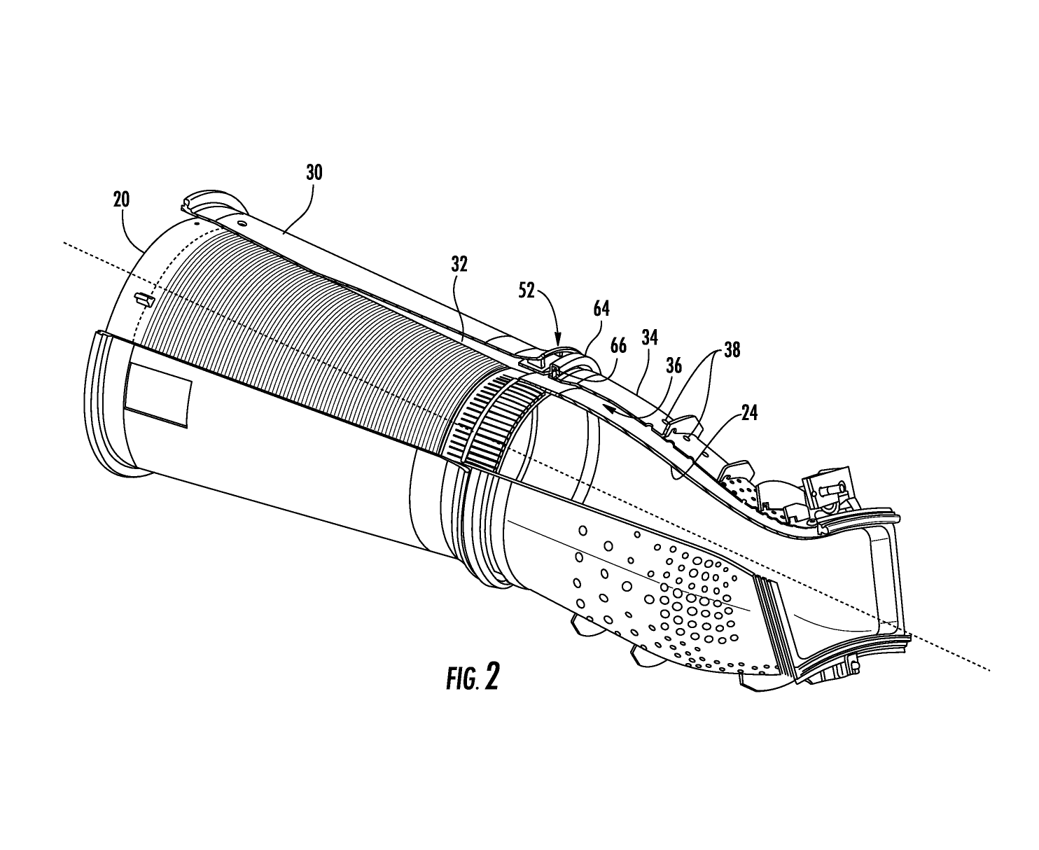

FIG. 1 provides a simplified cross-section of an exemplary combustor 10, such as may be included in a gas turbine, and FIG. 2 provides a perspective, partial cut-away view of a portion of the combustor 10 shown in FIG. 1 according to one embodiment of the present invention. As shown in FIG. 1, a casing 12 and an end cover 14 generally enclose the combustor 10, and one or more nozzles 16 may be radially arranged between the end cover 14 and an end cap 18. A generally cylindrical liner 20 is connected to the end cap 18, and the end cap 18 and liner 20 at least partially define a combustion chamber 22 downstream from the end cap 18. The liner 20 connects to a transition piece 24, and the transition piece 24 connects the combustion chamber 22 to a downstream component. For example, as shown in FIG. 1, the transition piece 24 may connect the combustion chamber 22 to a first stage nozzle 26 at the inlet of a turbine 28.

As shown in FIGS. 1 and 2, a flow sleeve 30 may circumferentially surround the liner 20 to define a first annular passage 32 between the liner 20 and the flow sleeve 30. Similarly, an impingement sleeve 34 may circumferentially surround the transition piece 24 to define a second annular passage 36 between the transition piece 24 and the impingement sleeve 34. The impingement sleeve 34 may include a plurality of flow holes 38, and a portion of the working fluid 40 flowing to the combustor 10 may flow through the flow holes 38 and into the second annular passage 36 between the transition piece 24 and the impingement sleeve 34. In this manner, the working fluid 40 may flow through the second annular passage 36 to provide impingement, convective, and/or conductive cooling to the outside of the transition piece 24.

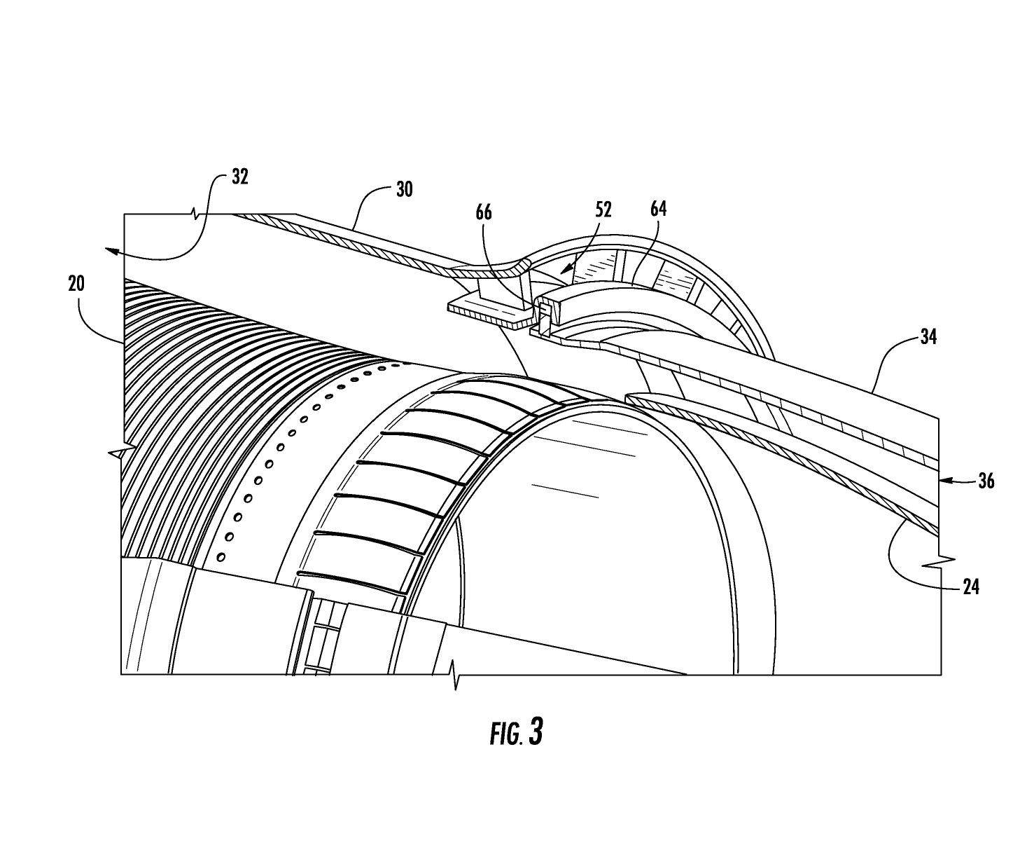

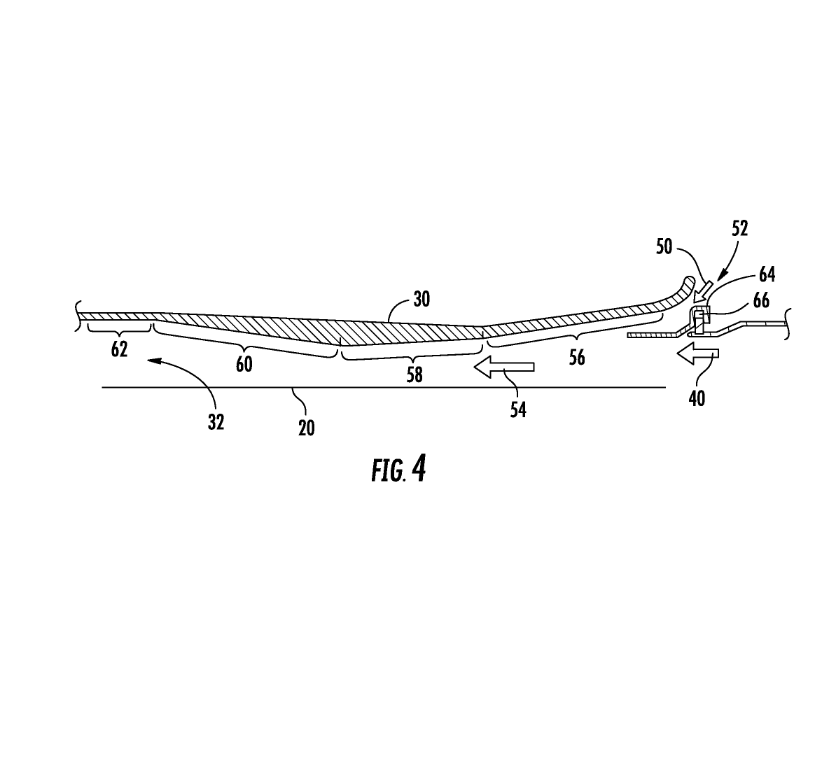

FIG. 3 provides an enlarged perspective, partial cut-away view of a portion of the combustor 10 shown in FIG. 2, and FIG. 4 provides a side cross-section view of the first annular passage 32 shown in FIG. 3. As shown, the first annular passage 32 generally surrounds a portion of the combustor 10 downstream (relative to the direction of the working fluid flow outside of the combustion chamber 22) from the second annular passage 36. A portion of the working fluid 50 may flow substantially axially through an axial injection inlet 52 in the flow sleeve 30 and into the first annular passage 32. The axial injection inlet 52 may be angled approximately 1-15 degrees with respect to the liner 20 so that the working fluid 50 entering the first annular passage 32 flows substantially parallel to the liner 20 to reduce the flow resistance and pressure drop as the working fluid 50 enters the first annular passage 32.

As shown in FIGS. 3 and 4, the second annular passage 36 merges with the first annular passage 32. As a result, the working fluid 40 flowing from the second annular passage 36 into the first annular passage 32 merges with the working fluid 50 entering the first annular passage 32 through the axial injection inlet 52. The first annular passage 32 generally includes converging and diverging sections of varying lengths that function similar to a nozzle to accelerate and combine the working fluid flows 40, 52. The convergence and divergence of the first annular passage 32 refers to the height or distance between the liner 20 and the flow sleeve 30 and may be accomplished in any of several ways. For example, the liner 20 and/or the flow sleeve 30 may be angled with respect to one another to create the desired convergence or divergence. Alternately, the thickness of the liner 20 and/or flow sleeve 30 may be varied along the first annular passage 32 to create the desired convergence or divergence.

In the particular embodiment shown in FIGS. 3 and 4, a first section 56 of the first annular passage 32 downstream from the axial injection inlet 52 converges at a first convergence rate to accelerate the working fluid 50 entering the first annular passage 32 through the axial injection inlet 52. In addition, the working fluid 50 axially injected into the first annular passage 32 creates a low pressure zone that further draws in or accelerates working fluid 40 flowing into the first annular passage 32 from the second annular passage 36. In this manner, the axial injection inlet 52 accelerates and combines multiple axial flows across the combustor 10.

A second section 58 of the first annular passage 32 downstream from the first section 56 may converge at a second convergence rate that is different than the first convergence rate. For example, as shown most clearly in FIG. 4, the second convergence rate may be less than the first convergence rate. In this manner, the second section 58 allows the working fluid 40 flowing from the second annular passage 36 to merge with the working fluid 50 flowing into the first annular passage 32 while still accelerating the combined working fluid flow 54 through the first annular passage 32.

A third section 60 of the first annular passage 32 downstream from the second section 58 may diverge at a first divergence rate to create a low pressure zone that reduces the velocity and increases the pressure of the combined working fluid flow 54 through the first annular passage 32. A fourth section 62 of the first annular passage 32 downstream from the third section 60 may have a substantially constant height. In this manner, the first two sections 56, 58 of the first annular passage 32 accelerate and mix the working fluid flows 40, 50, and the third and fourth sections 60, 62 of the annular passage 32 decelerate the combined working fluid flow 54 to reduce the overall pressure drop of the working fluid flow 54 across the liner 20 and/or combustor 10. The combined working fluid flow 54 flows through the first annular passage 32 to provide additional impingement, convective, and/or conductive cooling to the outside of the liner 20. The combined working fluid 54 then flows along the outside of the end cap 18 (most clearly shown in FIG. 1) until it reaches the end cover 14, where it reverses direction to flow through the nozzles 16 and into the combustion chamber 22.

As shown in FIGS. 3 and 4, an upstream portion 64 of the flow sleeve 30 may releasably or fixedly connect to the impingement sleeve 34 upstream from the first section 56, thereby simplifying the design, manufacturing costs, and maintenance costs associated with the flow sleeve 30. For example, as shown most clearly in FIG. 4, a split ring 66 may provide a releasable connection between the flow sleeve 30 and the impingement sleeve 34. Alternately or in addition, a weld bead, braze joint, clamp, or other mechanical device may connect the flow sleeve 30 to the impingement sleeve 34.

The various embodiments shown and described with respect to FIGS. 1-4 may also provide a method for supplying flow to the combustor 10. The method may include flowing the first portion 50 of the working fluid substantially axially through the first annular passage 32 that circumferentially surrounds at least a portion of the combustion chamber 22. The method may further include converging the first annular passage 32 at a first convergence rate, converging the first annular passage 32 at a second convergence rate downstream from the first convergence rate, wherein the second convergence rate is less than the first convergence rate, and/or diverging the first annular passage 32 at a first divergence rate downstream from the second convergence rate. In particular embodiments, the method may further include flowing the second portion 40 of the working fluid substantially axially through the second annular passage 36 that circumferentially surrounds at least a portion of the combustion chamber 22, wherein the second annular passage 36 is upstream from the first annular passage 32 and merging the first and second portions 50, 40 of the working fluid in the first annular passage 32.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A device for supplying flow to a combustor, comprising:
a. a flow sleeve configured to circumferentially surround the combustor, wherein the flow sleeve defines a first annular passage around the combustor;
b. a first section of the first annular passage that converges at a first convergence rate; and
c. a second section of the first annular passage downstream from the first section that converges at a second convergence rate that is less than the first convergence rate.

2. The device as in claim 1, further comprising an axial injection inlet upstream from the first section, wherein the axial injection inlet provides substantially axial fluid flow into the first annular passage.

3. The device as in claim 1, further comprising a third section of the first annular passage downstream from the second section, wherein the first annular passage diverges at a first divergence rate in the third section.

4. The combustor as in claim 3, further comprising a fourth section of the first annular passage downstream from the third section, wherein the annular passage has a substantially constant height in the fourth section.

5. A combustor, comprising:
a. a liner, wherein the liner at least partially defines a combustion chamber;
b. a flow sleeve that circumferentially surrounds the liner, wherein the liner and the flow sleeve define a first annular passage between the liner and the flow sleeve;
c. a first section of the first annular passage that converges at a first convergence rate; and
d. a second section of the first annular passage downstream from the first section that converges at a second convergence rate that is less than the first convergence rate.

6. The combustor as in claim 5, further comprising an axial injection inlet upstream from the first section, wherein the axial injection inlet provides substantially axial fluid flow into the first annular passage.

7. The combustor as in claim 5, further comprising a third section of the first annular passage downstream from the second section, wherein the first annular passage diverges at a first divergence rate in the third section.

8. The combustor as in claim 7, further comprising a fourth section of the first annular passage downstream from the third section, wherein the annular passage has a substantially constant height in the fourth section.

9. The combustor as in claim 5, further comprising a transition piece that connects the combustion chamber to a downstream component.

10. The combustor as in claim 9, further comprising an impingement sleeve that circumferentially surrounds the transition piece to define a second annular passage between the transition piece and the impingement sleeve.

11. The combustor as in claim 10, wherein the second annular passage merges with the first annular passage upstream from the second section of the first annular passage.

12. The combustor as in claim 10, wherein the flow sleeve is connected to the impingement sleeve upstream from the first section.

13. A method for supplying flow to a combustor, comprising:
a. flowing a first portion of a working fluid substantially axially through a first annular passage that circumferentially surrounds at least a portion of a combustion chamber;
b. converging the first annular passage at a first convergence rate; and
c. converging the first annular passage at a second convergence rate downstream from the first convergence rate, wherein the second convergence rate is less than the first convergence rate.

14. The method as in claim 13, further comprising diverging the first annular passage at a first divergence rate downstream from the second convergence rate.

15. The method as in claim 13, further comprising flowing a second portion of the working fluid substantially axially through a second annular passage that circumferentially surrounds at least a portion of the combustion chamber, wherein the second annular passage is upstream from the first annular passage.

16. The method as in claim 15, further comprising merging the first and second portions of the working fluid in the first annular passage.
